(19) United States
(12) Patent Application Publication
(10) Pub. No.: US 2026/0098837 A1
(43) Pub. Date: Apr. 9, 2026

(54) SENSOR SYSTEMS AND METHODS PROVIDING STRUCTURAL MONITORING

(71) Applicant: The Government of the United States of America, as represented by the Secretary of the Navy, Arlington, VA (US)

(72) Inventors: Logan L. Richardson, Washington, DC (US); Geoffrey A. Cranch, Fairfax Station, VA (US)

(73) Assignee: The Government of the United States of America, as represented by the Secretary of the Navy, Arlington, VA (US)

(21) Appl. No.: 18/918,504

(22) Filed: Oct. 17, 2024

Related U.S. Application Data
(60) Provisional application No. 63/545,078, filed on Oct. 20, 2023.

(51) Int. Cl. G01N 29/24; G01H 9/00; G01M 7/00; G01N 29/12; G01N 29/34; G01N 29/46

(52) U.S. Cl. CPC G01N 29/2418; G01N 29/12; G01N 29/348; G01H 9/004; G01M 7/00; G01N 29/46; G01N 2291/014; G01N 2291/0258

(57) ABSTRACT

Methods of monitoring a structure use first and second fiber laser sensors (FLSs) along an optical fiber. A pump laser signal is provided in the optical fiber, fundamental acoustic waves are excited on the structure, and secondary acoustic waves are generated in the structure in response to the fundamental acoustic waves. A first laser signal having a first laser wavelength that varies responsive to the fundamental and secondary acoustic waves is generated from the first FLS responsive to the pump laser signal. A second laser signal having a second laser wavelength that varies responsive to the fundamental and secondary acoustic waves is generated from the second FLS responsive to the pump laser signal. Amplitudes of the secondary acoustic waves at the first and second FLSs are determined based on the first and second laser signals. Structural health monitoring is performed based on the amplitudes of the secondary waves.

### CROSS-REFERENCE TO RELATED APPLICATIONS

This Application is a Nonprovisional Utility Patent Application and claims the benefit of priority under 35 U.S.C. Sec. 119 based on U.S. Provisional Patent Application No. 63/545,078 filed on Oct. 20, 2023. The disclosure of Provisional Application No. 63/545,078 and the disclosures of all references cited herein are hereby incorporated in their entirety by reference into the present disclosure.

### FEDERALLY SPONSORED RESEARCH AND DEVELOPMENT

The United States Government has ownership rights in this invention. Licensing inquiries may be directed to Office of Technology Transfer, US Naval Research Laboratory, Code 1004, Washington, D.C. 20375, USA; +1.202.767.7230; nrltechtran@us.navy.mil, referencing Navy Case #212837-US2.

### TECHNICAL FIELD

The present disclosure relates to sensors, and more particularly to systems including fiber laser sensors and related methods.

### BACKGROUND OF THE INVENTION

Advances in fiber laser sensing have created promising new avenues to evaluate the structural health of large platforms using a single optical fiber (see, Reference [1]). In parallel, recent advances in nonlinear guided wave acoustics provide a new methods to detect micro-defects and distributed damage in a structure using non demolition evaluation (see, Reference [2]).

Improvements in structural health monitoring techniques may not only be used to reduce/prevent catastrophic failures of structures by detecting damage before it is visible, but may also provide a path to condition-based maintenance, reducing overall costs in upkeep (see, Reference [3]). This may be especially significant for intricate large-scale platforms such as ships, or difficult-to-access structures such as wind turbines.

### SUMMARY OF THE INVENTION

This summary is intended to introduce in simplified form, a selection of concepts that are further described in the Detailed Description. This summary is not intended to identify key or essential features of the claimed subject matter, nor is it intended to be used as an aid in determining the scope of the claimed subject matter. Instead, it is merely presented as a brief overview of the subject matter described and claimed herein.

According to some embodiments of inventive concepts, a sensor system is provided for a structure to be monitored, and the sensor system includes an optical fiber, a pump laser, first and second fiber laser sensors, a piezoelectric transducer, and a controller. The pump laser provides a pump laser signal having a pump laser wavelength in the optical fiber. The first and second fiber laser sensors are arranged in series along the optical fiber, and each of the first and second fiber laser sensors is mounted on the structure. The first fiber laser sensor provides a laser signal having a first laser wavelength responsive to the pump laser signal, and the second fiber laser sensor provides a second laser signal having a second laser wavelength responsive to the pump laser signal. Moreover, the first and second laser wavelengths are different. The piezoelectric transducer is mounted on the structure to be tested, and the piezoelectric transducer is configured to generate fundamental acoustic waves in the structure having a fundamental frequency. Secondary acoustic waves are generated in the structure in response to the fundamental acoustic waves, and the secondary waves have a nonlinear interaction frequency that is different than the fundamental frequency. The first laser wavelength varies in response to the fundamental and secondary acoustic waves, and the second laser wavelength varies in response the fundamental and secondary acoustic waves. The controller is coupled with the optical fiber, and the controller is configured to determine amplitudes of the secondary acoustic waves having the nonlinear interaction frequency at the first and second fiber laser sensors based on the first and second laser signals having the respective first and second laser wavelengths. The controller is further configured to perform structural health monitoring based on the amplitudes of the secondary waves at the first and second fiber laser sensors.

According to some other embodiments of inventive concepts, a method is provided to monitor a structure using first and second fiber laser sensors mounted at respective first and second locations on the structure, with the first and second fiber laser sensors being arranged in series along an optical fiber. A pump laser signal having a pump laser wavelength is provided in the optical fiber. Fundamental acoustic waves are excited at a third location on the structure spaced apart from the first and second locations, and the fundamental acoustic waves have a fundamental frequency. Secondary acoustic waves are generated in the structure in response to the fundamental acoustic waves, and the secondary acoustic waves have a nonlinear interaction frequency that is different than the fundamental frequency. A first laser signal is generated from the first fiber laser sensor in response to the pump laser signal, with the first laser signal having a first laser wavelength that varies in response to the fundamental and secondary acoustic waves at the first location on the structure. A second laser signal is generated from the second fiber laser sensor in response to the pump laser signal, with the second laser signal having a second laser wavelength that varies in response the fundamental and secondary acoustic waves at the second location on the structure. Moreover, the first and second laser wavelengths are different. Amplitudes of the secondary acoustic waves having the nonlinear interaction frequency at the first and second fiber laser sensors are determined based on the first and second laser signals having the respective first and second laser wavelengths. Structural health monitoring is performed based on the amplitudes of the secondary waves at the first and second fiber laser sensors.

### BRIEF DESCRIPTION OF DRAWINGS

Examples of embodiments of inventive concepts may be more clearly understood from the following detailed description taken in conjunction with the accompanying drawings in which:

FIG. 1 is a schematic diagram illustrating an experimental setup used to measure nonlinear wave conversion according to some embodiments of inventive concepts;

FIG. 2A is a graph illustrating amplitudes of the fundamental frequency at the two measurement points of FIG. 1;

FIG. 2B is a graph illustrating nonlinear coefficients calculated at the two measurement points for both sensitized and pristine plates according to some embodiments of inventive concepts;

FIG. 3A illustrates short term Fourier transforms of signals from a two frequency Lamb wave excitation in a pristine composite panel according to some embodiments of inventive concepts;

FIG. 3 illustrates short term Fourier transforms of signals from a two frequency Lamb wave excitation in a composite panel with a single layer 1 mm delamination according to some embodiments of inventive concepts; and

FIG. 4 is a schematic diagram illustrating a sensor system according to some embodiments of inventive concepts.

### DETAILED DESCRIPTION OF THE INVENTION

Aspects and features of the present disclosure are described herein with reference to the accompanying drawings. The description shows, by way of example, combinations and configurations in which aspects, features, and embodiments of inventive concepts can be put into practice. It will be understood that the disclosed aspects, features, and/or embodiments are merely examples, and that one skilled in the art may use other aspects, features, and/or embodiments or make functional and/or structural modifications without departing from the scope of the present disclosure. Moreover, like reference numerals/descriptors refer to like elements throughout, and sizes of each of the elements may be exaggerated for clarity and/or conciseness of explanation.

Distributed damage, such as micro-cracks and corrosion, can be measured before becoming large enough to be visibly seen using non-linear Lamb wave mixing techniques. In the present disclosure, novel techniques of non-linear Lamb wave mixing are provided using compact and sensitive fiber laser sensors. Moreover, the applicability of fiber laser sensors to nonlinear guided wave acoustic sensing is demonstrated for the purpose of defect detection in aluminum and carbon fiber composite delamination.

One method to probe the degree of degradation in a material is to use guided wave acoustics, where exogenous vibrations are coupled into the material and the propagation of these vibrations through the material is measured. By monitoring the response, it is possible to ascertain the health of the guiding material. In a thin plate-like structure, these vibrations manifest as Lamb waves. The generated Lamb waves impinging on large defects, such as cracks, will reflect vibrations or alter propagation in transmission which can then be measured. By extending this framework into the nonlinear regime, it is possible to increase the sensitivity of this method to detect distributed or much smaller defects. As damage accrues, Lamb waves in the medium will begin to exhibit nonlinear behavior. Measuring and characterizing the nonlinearity of a material can be used as a proxy to determine the degree of damage. It is possible to expand the Lamb wave model to incorporate a nonlinear stress-strain relationship of the plate which may then allow modeling of how these vibrations interact with themselves, allowing for even more information to be extracted from the material.

This technique lends itself well to fiber-based sensing due to the fact that multiple sensors can be spliced onto to an individual fiber with an arbitrary amount of passive fiber separating the sensors. This allows for a single optical fiber to provide information over a large structure. Previous efforts to perform structure health monitoring (SHM) with fiber-based sensors utilized fiber Bragg gratings (FBGs) which were inscribed into an optical fiber. Vibrations coupled into the sensor, either directly or remotely, induce strain and therefore small changes the FBG length. By interrogating these small changes in length using a probe signal in either transmission or reflection, it is possible to measure the incoming vibration. Previous work (see Reference [4]) has demonstrated that the signal from these sensors can be increased by inscribing the FBG into a photosensitive erbium doped fiber, creating a fiber laser sensor (FLS). These FLSs can be multiplexed to allow for distributed sensing over a large area. The signal from each sensor can be individually addressed allowing spatial mapping of which signal originates from each laser sensor.

In the present disclosure, fiber Bragg grating (FBG) based fiber laser sensors (FLSs) are used to measure the nonlinear interaction of Lamb waves in a plate incorporating defects. Specifically, measurements are performed in sensitized aluminum plates and delaminated carbon fiber composite. These FLSs can be multiplexed to allow for distributed sensing over a large area. The signal from each sensor can be individually addressed to allow spatially mapping of which signal originates from each sensor.

Non-linear Lamb-wave Mixing is discussed below.

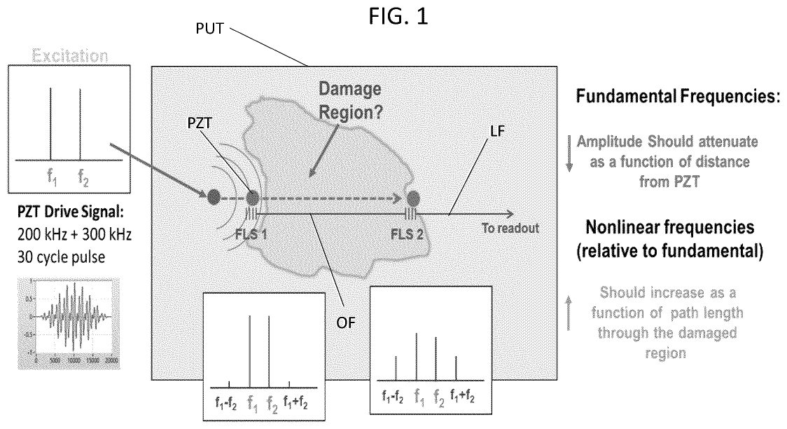

Within an isotropic plate-like structure, with a thickness d, the general solutions to the wave equation are governed by the Lamb-wave solutions. The solution to this wave equation gives a set of equations that can be either an anti-symmetric mode Aₙ or a symmetric mode Sn, where n is the mode number. The solutions to this equation are dispersive. In a nonlinear medium, the interactions of Lamb waves can be modeled using the nonlinear stress strain relationship,

$$σ = E \cdot ε ( 1 + βε + h . o . t ) , \qquad Equation ( 1 )$$

where β is the nonlinear strain coefficient, E is Young's modulus, ε is the strain, and σ is the stress. If the degree of nonlinearity is small enough, this can be modeled as a perturbation. For a two-frequency solution, mixing products may be obtained at frequencies f₁+f₂ and f₂−f₁. Increased nonlinear interaction will increase the amplitudes of these mixing products, as illustrated in FIG. 1. Here, the concept of exciting two frequencies in a plate and measuring nonlinear conversion with sensors located at different distances from the source is shown.

In this nonlinear framework, the solution to the wave equation for a two-frequency excitation yields mixing products between the two fundamental tones. This solution implies that for a higher degree of nonlinearity, interference between the two excitation frequencies f₁ and f₂ should be expected, whereas this should be reduced/minimal for a linear solution. The degree of nonlinear interaction is dependent on the nonlinear strain coefficient β, which increases as a function of damage within the plate (see Reference [5]). The nonlinear strain coefficient can be estimated by looking at the ratio of the amplitudes of the nonlinear interaction frequencies relative to the fundamental tones,

$$β = \frac{{A}_{f 1 + f 2}}{{A}_{f 1} \cdot {A}_{f 2}} \qquad Equation ( 2 )$$

where A_{f1} and A_{f2} are the amplitudes of the measured signal at the fundamental frequencies, and A_{f1+f2} is the amplitude of the summation mixing frequency. This solution implies that for a higher degree of nonlinearity, interference between the two excitation frequencies f₁ and f₂ should be expected, whereas this should be reduced/minimal for a linear solution as illustrated in FIG. 1. The degree of nonlinearity β is dependent on the level of damage within the plate (see Reference [5]). By monitoring the level of nonlinear interaction, it is then possible to characterize the degree of damage in a plate.

FIG. 1 Illustrates an experimental setup used to measure nonlinear wave conversion caused by two frequency excitation in a plate. Two Lamb waves with frequencies f₁ and f₂ are excited using piezoelectric transducer (PZT) as excitation source PZT and the mixing product amplitudes are measured with sensor FLS1 located close-in to the excitation source PZT (e.g., 2 cm from excitation source PZT) and with sensor FLS2 located at a distance from the excitation source PZT (e.g., 20 cm from excitation source PZT). The region separated by sensors FLS1 and FLS2 exhibits high levels of sensitization. FIG. 1 shows the concept of exciting two frequencies in a plate under test PUT and measuring nonlinear conversion with sensors FLS1 and FLS2 located at different distances from excitation source PZT. In a damaged plate, an increase in the nonlinear coefficient as a function of propagation distance should be observed, when compared to a defect free plate. By measuring and characterizing the nonlinear strain coefficient for a given plate, it is then possible to estimate the degree of damage in a plate.

An experimental setup is discussed below.

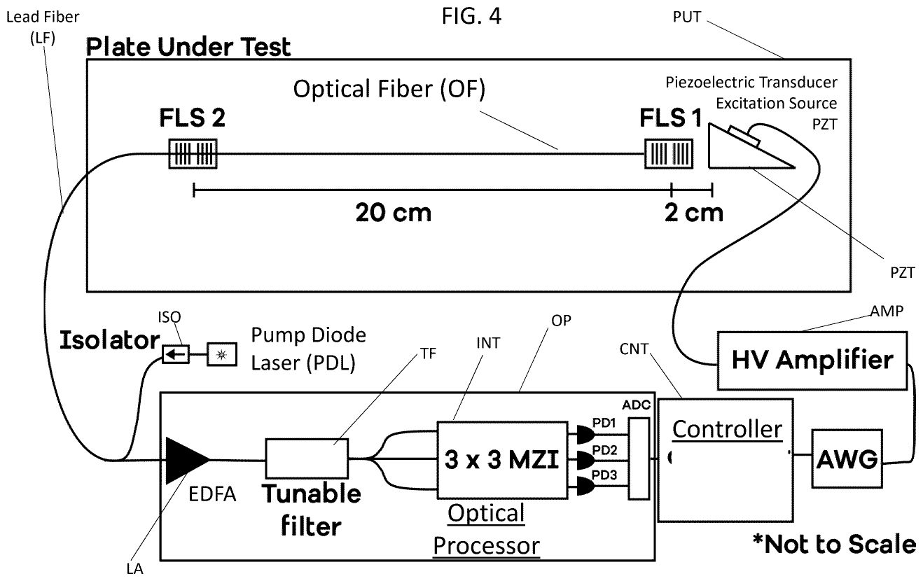

In an experimental demonstration illustrated in FIG. 4, two fiber laser sensors FLS1 and FLS2 were spliced to a segment of passive optical fiber OF (SMF-28) such that the two sensors FLS1 and FLS2 were spaced 20 cm apart. The primary lasing frequencies of the fiber laser sensors FLS1 and FLS2 were measured to be at λ₁=1551.67 nm and λ₂=1553.35 nm. Pump light from pump laser diode PLD was generated at 980 nm, then sent to through 3 m of SMF-28 lead fiber LF, to reach the two fiber laser sensors FLS1 and FLS2. Light from the fiber laser sensors FLS1 and FLS2 traversed back through the lead fiber LF and was transmitted through a DiCon MEMS Tunable filter TF which was serially controlled. Tunable filter TF was adjusted to receive signals from a specified fiber laser sensor FLS1 or FLS2. The transmitted light was then sent through optical processor OP including tunable filter TF, a 3×3 Mach-Zehnder interferometer INT (to convert phase fluctuations into intensity fluctuations) (see Reference [1]), photodiodes PD1, PD2, and PD3, and analog-to-digital converter ACD. The signals were converted into interferometric phase.

Measurements were performed on four structures: a damaged aluminum plate, a pristine aluminum plate, a carbon fiber plate, and a composite plate with pre-engineered delaminations. An 8 mm think section of sensitized T6061 aluminum was used as the damaged plate. The composite plates were produced from 9 layers of a carbon fiber weave impregnated with an epoxy and had dimensions of 91.44 cm×30.48 cm×1.5 mm. A second composite plate was constructed in the same fashion, although with three pre-engineered delaminations at specified locations within the plate.

The excitation PZT signal was generated by arbitrary waveform generator AWG as a 30 cycle Hamming windowed pulse with two frequencies, 200 kHz and 300 kHz. The excitation PZT signal was amplified using High Voltage (HV) amplifier AMP (e.g., a Tegram Inc. 2340 precision power amplifier) and sent to excitation source PZT. When bonding the fiber OF to a plate under test, a thin layer of Krytox grease was first applied to the structure, then, the entire fiber was bonded to the plate to reduce/minimize reflections or remote bonding artifacts (see Reference [6]).

Excitation source PZT was provided using a Steminc SMD15T12S412 PZT bonded to a polylactic acid PLA wedge (see Reference [7]) to improve coupling into the composite plate. The first fiber laser sensor FLS1 (operating at wavelength λ₁) was bonded at a distance 2 cm from excitation source PZT, and second fiber laser sensor FLS2 (operating at wavelength λ₂) was bonded at a distance of 22 cm from excitation source PCT. An excitation was triggered from controller CNT via control program, which would trigger arbitrary waveform generator AWG, and induce a vibration from excitation source PZT into the plate under test. Output signals from photodetectors PD1, PD2, and PD2 would then be recorded for a given fiber laser sensor FLS1/FLS2. The recorded signals from fiber laser sensors FLS1 and FLS2 were bandpass filtered with a window of 50 kHz around the excitation and nonlinear interaction frequencies and respective amplitudes were extracted. This measurement was repeated 660 times, and averaged at each gain value of the source PZT amplifier and the signal was compared at the 2 cm and 22 cm locations. This test was repeated for the undamaged plate.

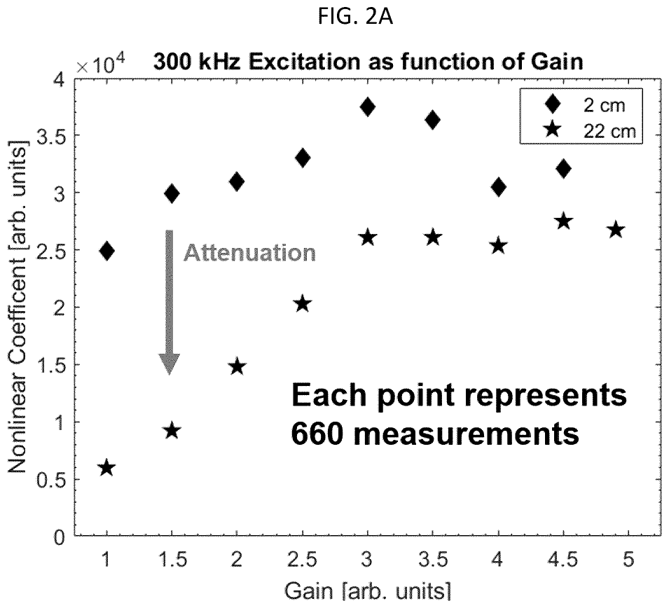

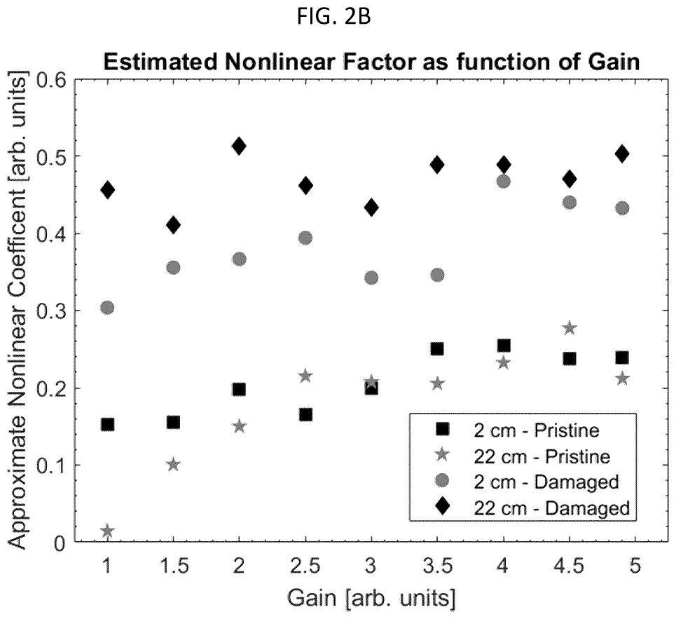

Values of the averaged amplitudes at one of the fundamental frequencies (300 kHz) in the sensitized plate is shown in FIG. 2A. The measured amplitude of the 300 kHz excitation is shown to decrease as expected with distance from excitation source PZT. FIG. 2B shows the calculated nonlinear coefficient measured at 500 kHz at the 2 cm location of fiber laser sensor FLS1 and at the 22 cm location of fiber laser sensor FLS2 in both the sensitized plate and pristine plate. In the sensitized plate, the nonlinear strain coefficient is found to increase with distance from excitation source PZT, however, the nonlinear strain coefficient remains comparable with distance from excitation source PZT in the pristine plate case. The nonlinear coefficient is also found to increase with source amplitude. The overall nonlinear strain coefficient is also found to be around a factor of 2 higher in the sensitized plate compared with the pristine plate, which may provide a useful measure of material degradation due to sensitization.

FIG. 2A illustrates amplitudes of the fundamental frequency at the two measurement points, and FIG. 2B illustrates the nonlinear coefficient calculated at the two measurement points (inset) for both the sensitized and pristine plates.

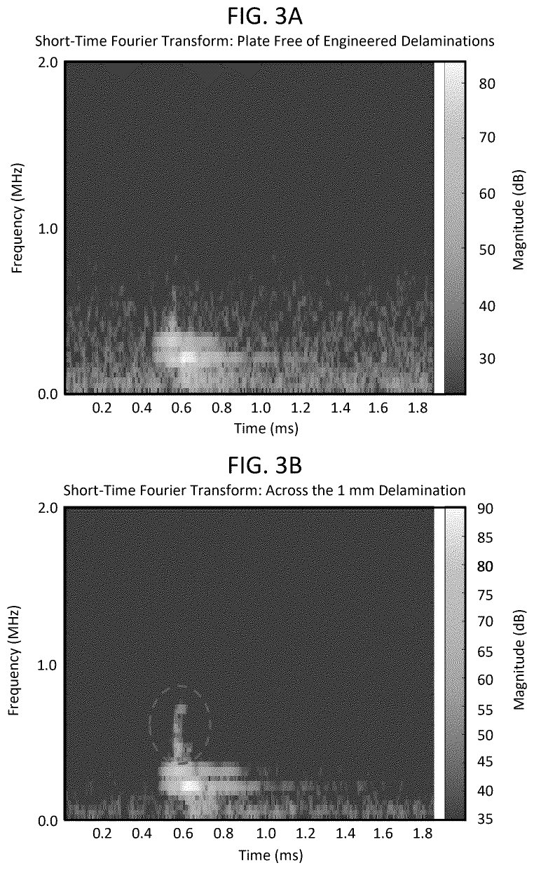

Lamb-wave propagation in a composite material can be difficult to model due to the variances in structure and epoxy used to impregnate the substrate. Additionally, the multi-layer aspect of the composites can cause reflections. For this reason, how nonlinear propagation occurs within the composite plate was experimentally determined, and delamination locations within the plate were experimentally measured using the non-linear lamb wave mixing (NLLWM) technique. FIG. 3A show preliminary results of the nonlinear mixing between two frequencies that occurs in a composite with a pre-engineered delamination. FIG. 3A shows the short-term Fourier transform of the signals measured across a pristine plate, and FIG. 3B shows the signals across a single layer 1 mm delamination. The increased amplitude of the mixing product at f₁+f₂ is clearly visible in the plate with a delamination. These measurements were taken using a Mistras PZT receiver and are currently being repeated using a fiber laser FLS receiver.

FIG. 3A illustrates short time Fourier transform of signals from a two frequency Lamb wave excitation in a pristine composite panel, and FIG. 3B illustrates short time Fourier transform of signals from a two frequency Lamb wave excitation in a composite panel with a single layer 1 mm delamination.

It has been shown in the foregoing disclosure that measuring nonlinear conversion in a two frequency Lamb wave excitation may provide a promising way to identify material degradation caused by sensitization in aluminum and delamination in composite panels.

FIG. 4 is a schematic diagram illustrating embodiments of a fiber optic acoustic sensor system that may be used to monitor structural health of a structure (shown as a plate under test PUT) using non-linear interactions of acoustic waves according to some embodiments of inventive concepts. Operations of the sensor system and elements thereof are discussed above, and further disclosure is provided below.

As shown, pump diode laser PDL is configured to provide a pump laser signal through lead fiber LF to a plurality of fiber laser sensors FLS1 and FLS2 that are provided along optical fiber OF. Each fiber laser sensor is configured to provide a fiber laser signal at a respective laser wavelength into the optical fiber responsive to the pump laser signal, and each fiber laser sensor generates a laser wavelength that is different than laser wavelengths of the other fiber laser sensors of the sensor system. Optical fiber OF and lead fiber LF are substantially passive, and each fiber laser sensor may be spliced into optical fiber OF, with portions of optical fiber OF separating each fiber laser sensor. As defined herein, optical fiber OF may thus include discontinuous segments of optical fiber with a respective fiber laser sensor spliced between adjacent segments of the fiber layer sensor. Moreover, lead fiber LF may be considered as an element of optical fiber OF.

Each fiber laser sensor FLS1 and FLS2 may include a fiber Bragg grating FBG that is used to passively sense acoustic waves passing though the structure of the plate under test PUT adjacent to the respective fiber laser sensors FLS1 and FLS2. Each fiber laser sensor is mechanically coupled to a respective location on the structure, and the laser wavelength of the fiber laser sensor varies in response to acoustic waves passing through the structure at that location (due to varying strain in the fiber laser sensor resulting from the acoustic waves). Each fiber laser sensor can thus generate a respective fiber laser signal at a respective laser wavelength that varies in response to acoustic waves passing through the structure, and these respective fiber laser signals can thus be used to detect/measure the acoustic waves at the different locations on the structure where the fiber laser sensors are coupled.

Fiber laser sensors based on fiber Bragg gratings are discussed, for example, in Reference [5] (C. R. S. Williams, et al., “Multichannel fiber laser acoustic emission sensor system for crack detection and location in accelerated fatigue testing of aluminum panels,” APL Photon., Vol. 5, Iss. 3, 030803, Mar. 20, 2020), the disclosure of which is hereby incorporated herein in its entirety by reference. While two fiber laser sensors FLS1 and FLS2 are shown in the system diagram of FIG. 4, any number of fiber laser sensors FLS may be included in series along optical fiber OF to provide any number of sensing locations along the structure of plate under test PUT, where each fiber laser sensor has a different laser wavelength. Moreover, the distances illustrated in the system diagram (e.g., 20 cm between FLS1 and FLS2 and two cm between FLS1 and the piezoelectric transducer excitation source PZT) are merely examples provided for purposes of experimental demonstrations discussed above, and any distances may be provided.

Isolator ISO may be included between pump diode laser PDL and the lead fiber LF (also referred to as lead optical fiber). While not explicitly shown, a circulator may also be included to couple the pump laser signal into lead fiber LF and to couple the fiber laser signals from the fiber laser sensors from the lead fiber LF into the optical processor OP.

In addition, piezoelectric transducer excitation source PZT is mechanically mounted on the structure of plate under test PUT, and piezoelectric transducer excitation source PZT is configured to generate acoustic waves that are coupled into the structure of plate under test PUT where the acoustic waves have an acoustic wave frequency. The piezoelectric transducer excitation source PZT, for example, may be a lead zirconate titanate (PZT) transducer, with a layer of PZT between two electrodes. As shown in the system diagram of FIG. 4, the piezoelectric transducer excitation source PZT and fiber laser sensors FLS1 and FLS2 may be arranged in a line. According to some other embodiments, the piezoelectric transducer excitation source PZT and fiber laser sensors FLS1 and FLS2 may define a triangle or other nonlinear arrangement.

As shown in FIG. 4, controller CNT is coupled to analog-to-digital controller ADC of optical processor OP and to arbitrary waveform generator AWG. According to some embodiments, controller CNT may include processor circuitry (also referred to as a processor), interface circuitry (also referred to as an interface) coupled with processor circuitry, and memory circuitry (also referred to as memory) coupled with processor circuitry. The interface circuitry is configured to couple information/signaling from analog-to-digital converter ADC to processor circuitry and to couple control signaling from processor circuitry to arbitrary waveform generator AWG. The memory circuitry may include computer readable program code that when executed by the processing circuitry causes the processing circuitry to perform operations according to embodiments disclosed herein. According to other embodiments, the processing circuitry may be defined to include memory so that separate memory circuitry is not required. Accordingly, the processor circuitry of controller CNT may be configured to transmit control signaling through interface circuitry to control arbitrary waveform generator AWG as disclosed herein, to receive information/signaling from analog-to-digital converter ADC (of optical processor OP) through interface circuitry, and to process the information/signaling to determine amplitudes of the secondary acoustic waves and perform structural health monitoring as disclosed herein.

More particularly, the piezoelectric transducer excitation source PZT is driven by controller CNT, arbitrary waveform generator AWG, and HV amplifier AMP to produce fundamental acoustic waves at multiple fundamental frequencies f₁ and f₂ (e.g., at 200 kHz and at 300 kHz according to examples discussed above), and due to nonlinear interactions in the structure, secondary acoustic waves at nonlinear interaction frequencies (e.g., at f₃=f₁+f₂, and at f₄=f₁−f₂) are also generated in the structure. The fundamental and secondary acoustic waves travel through the structure of plate under test PUT and apply varying strain to each fiber laser sensor FLS1 and FLS2 as they pass through portions of the structure of plate under test PUT adjacent a respective fiber laser sensor (also referred to as measurement locations on the structure). While two fundamental frequencies and two nonlinear interaction frequencies are discussed by way of example, any number of fundamental frequencies and nonlinear interaction frequencies may be used. The nonlinear interaction frequencies are different than the fundamental frequencies, and the nonlinear interaction frequencies are different than frequencies used to drive the piezoelectric transducer.

Optical processor OP receives the laser signals from fiber laser sensors FLS1 and FLS2 though optical fiber OF and lead fiber LF, and because each fiber laser sensor generates a laser signal at a different wavelength, optical processor OP can discriminate between the laser signals of the different fiber laser sensors using tunable filter TF. As shown, optical processor OP may include a laser amplifier LA (e.g., an erbium-doped fiber amplifier EDFA), tunable filter TF, a 3×3 Mach Zender Interferometer INT (that converts phase fluctuations of a laser signal from a fiber laser sensor into amplitude fluctuations), photodiodes PD1, PD2, and PD3 (that convert the amplitude fluctuations into analog electrical signals), and analog-to-digital converter ADC (that converts the analog electrical signals to digital signals). Accordingly, optical processor OP converts the laser signals to digital signals that can be processed by the controller CNT (also referred to as a computer).

Tunable filter TF can thus be used to separately provide information of laser signals from respective fiber laser sensors to controller CNT sequentially in time, or multiple filters (and corresponding MZIs, photodetectors, and ADCs) may be used to provide information of laser signals from respective fiber laser sensors to controller CNT in parallel.

Controller CNT also controls arbitrary waveform generator AWG to generate a specific voltage pattern to create a pulse including the multiple fundamental frequencies. This pulse may be amplified by High Voltage Amplifier AMP and used to drive the piezoelectric transducer excitation source PZT, thereby producing the fundamental acoustic waves at the fundamental frequencies. Moreover, controller CNT may control timing of the piezoelectric transducer excitation source PZT (via AWG and HV Amplifier) and optical processor OP to run the piezoelectric excitations in time with recording the laser signals from the fiber laser sensors FLS1 and FLS2.

Accordingly, controller CNT can determine amplitudes of the fundamental acoustic waves at the fundamental frequencies (e.g., f₁ and f₂) and amplitudes of the secondary acoustic waves at the nonlinear interaction frequencies (e.g., at f₃=f₁+f₂, and at f₄=f₁−f₂) at the respective fiber laser sensors FLS1 and FLS2 based on the respective laser signals. Based on variations in these amplitudes at the different fiber laser sensors FLS1 and FLS2, controller CNT can perform structural health monitoring to detect defects (e.g., cracks, corrosion, delamination, etc.) in the structure of plate under test PUT.

Embodiments of the system diagram of FIG. 4 show that optical processor OP and pump diode laser PDL are coupled to a same end of optical fiber OP, for example, using a circulator to provide the coupling. According to some other embodiments, optical processor OP and pump diode laser PDL may be coupled to opposite ends of optical fiber OF without a circulator.

While the system diagram of FIG. 4 shows two fiber laser sensors FLS1 and FLS2 coupled in series along optical fiber OF, any number of fiber laser sensors may be coupled in series along optical fiber OF and coupled to the structure at respective locations and operated at respective wavelengths to provide sensing over a large area of a structure. Moreover, some embodiments herein discuss excitation of fundamental acoustic waves at two fundamental frequencies, but any number of fundamental frequencies (including one or more) may be used according to some embodiments of inventive concepts. Similarly, any number of resulting nonlinear interaction frequencies (including one or more) may be used to monitor the structure.

Sensors according to some embodiments of inventive concepts may provide sensors to monitor large structures using a single optical fiber with multiple fiber laser sensors spliced along a length of the optical fiber. By monitoring nonlinear interactions of Lamb waves within the structure of interest, it is possible to detect defects with increased sensitivity and/or to detect damage (e.g., corrosion) that is distributed over a larger area. Moreover, the ability to multiplex fiber laser sensors in series along a length of a single optical fiber may significantly reduce a footprint of the sensor device on the structure being monitored. In addition, sensors according to some embodiments of inventive concepts may provide detection of cracks, corrosion, material fatigue, and/or other damage/defects before such damage/defects become visible or detectable by know techniques.

Direct application of the fiber laser sensors to the structure under test is not required according to some embodiments of inventive concepts. Instead, remote bonding may be used to mechanically couple the optical fiber to the structure under test (e.g., a plate as discussed above), using the optical fiber as an acoustic wave guide.

Sensor systems/methods according to some embodiments of inventive concepts may thus provide low cost, low weight, and persistent structural health monitoring (SHM), and such systems/methods may be used with multifunctional materials. For example, sensor systems/methods according to some embodiments of inventive concepts may be used to provide SHM in various platforms such as ships, submersibles, land vehicles, and/or aircraft. Moreover, such sensor systems/methods may be modular, reconfigurable, and/or multiparameter.

Some example embodiments of inventive concepts are provided below.

Embodiment 1. A sensor system for a structure to be monitored, the sensor system comprising: an optical fiber (OF); a pump laser (PLD) that provides a pump laser signal having a pump laser wavelength in the optical fiber (OF); first and second fiber laser sensors (FLS1, FLS2) arranged in series along the optical fiber (OF), wherein each of the first and second fiber laser sensors is mounted on the structure, wherein the first fiber laser sensor (FLS1) provides a laser signal having a first laser wavelength (λ₁) responsive to the pump laser signal, wherein the second fiber laser sensor (FLS2) provides a second laser signal having a second laser wavelength (λ₂), wherein the first and second laser wavelengths are different; a piezoelectric transducer (PZT) mounted on the structure to be tested, wherein the piezoelectric transducer is configured to generate fundamental acoustic waves in the structure having a fundamental frequency, wherein secondary acoustic waves are generated in the structure in response to the fundamental acoustic waves, wherein the secondary waves have a nonlinear interaction frequency that is different than the fundamental frequency, wherein the first laser wavelength (λ₁) VARIES IN RESPONSE TO THE FUNDAMENTAL AND SECONDARY ACOUSTIC WAVES, AND WHEREIN THE SECOND laser wavelength (λ₂) varies in response the fundamental and secondary acoustic waves; and a controller (CNT) coupled with the optical fiber (OF), wherein the controller (CNT) is configured to determine amplitudes of the secondary acoustic waves having the nonlinear interaction frequency at the first and second fiber laser sensors based on the first and second laser signals having the respective first and second laser wavelengths, and to perform structural health monitoring based on the amplitudes of the secondary waves at the first and second fiber laser sensors.

Embodiment 2. The sensor system of Embodiment 1, wherein the piezoelectric transducer is configured to generate the fundamental acoustic waves in the structure having first and second fundamental frequencies (f₁ and f₂), wherein the secondary acoustic waves have first and second nonlinear interaction frequencies (f₃ and f₄) that are different than the first and second fundamental frequencies, and wherein the controller (CNT) is configured to determine amplitudes of secondary acoustic waves having the first and second nonlinear interaction frequencies at the first and second fiber laser sensors, and wherein the controller (CNT) is configured to perform structural health monitoring based on the amplitudes of the secondary acoustic waves at the first and second nonlinear interaction frequencies.

Embodiment 3. The sensor system of Embodiment 2, wherein the controller (CNT) is further configured to determine amplitudes of the fundamental acoustic waves having the first and second fundamental frequencies at the first and second fiber laser sensors based on the first and second laser signals, and wherein the controller (CNT) is configured to perform structural health monitoring based on the amplitudes of the fundamental acoustic waves having the first and second fundamental frequencies at the first and second fiber laser sensors and based on the amplitudes of the secondary acoustic waves having the first and second nonlinear frequencies at the first and second fiber laser sensors.

Embodiment 4. The sensor system of any of Embodiments 1-3, wherein the controller (CNT) is configured to perform structural health monitoring based on a comparison of the amplitudes of the fundamental and secondary acoustic waves at the first fiber laser sensor with amplitudes of the fundamental and secondary acoustic waves at the second fiber laser sensor.

Embodiment 5. The sensor system of any of Embodiments 1-4, wherein performing structural health monitoring comprises identifying a defect in the structure.

Embodiment 6. The sensor system of Embodiment 5, wherein the defect comprises at least one of corrosion, cracking, and/or delamination.

Embodiment 7. The sensor system of any of Embodiments 1-6, wherein the secondary acoustic waves are generated in the structure due to nonlinear wave mixing in response to the fundamental acoustic waves.

Embodiment 8. The sensor system of any of Embodiments 1-7 further comprising: an optical processor (OP) coupled between the optical fiber (OF) and the controller (CNT), wherein the optical processor (OP) is configured to filter out the second laser wavelength to generate a first digital signal corresponding to the first laser signal and to filter out the first laser wavelength to generate a second digital signal corresponding to the second laser signal, wherein the controller (CNT) is configured to determine the amplitudes based on the first and second digital signals.

Embodiment 9. A method of monitoring a structure using first and second fiber laser sensors (FLS1, FLS2) mounted at respective first and second locations on the structure, wherein the first and second fiber laser sensors (FLS1, FLS2) are arranged in series along an optical fiber (OF), the method comprising: providing a pump laser signal having a pump laser wavelength in the optical fiber (OF); exciting fundamental acoustic waves at a third location on the structure spaced apart from the first and second locations, wherein the fundamental acoustic waves have a fundamental frequency, wherein secondary acoustic waves are generated in the structure in response to the fundamental acoustic waves, and wherein the secondary acoustic waves have a nonlinear interaction frequency that is different than the fundamental frequency; generating a first laser signal from the first fiber laser sensor (FLS1) in response to the pump laser signal, wherein the first laser signal has a first laser wavelength (λ₁) that varies in response to the fundamental and secondary acoustic waves at the first location on the structure; generating a second laser signal from the second fiber laser sensor (FLS2) in response to the pump laser signal, wherein the second laser signal has a second laser wavelength (λ₂) that varies in response the fundamental and secondary acoustic waves at the second location on the structure, wherein the first and second laser wavelengths are different; determining amplitudes of the secondary acoustic waves having the nonlinear interaction frequency at the first and second fiber laser sensors (FLS1, FLS2) based on the first and second laser signals having the respective first and second laser wavelengths; and performing structural health monitoring based on the amplitudes of the secondary waves at the first and second fiber laser sensors.

Embodiment 10. The method of Embodiment 9, wherein exciting the fundamental acoustic waves comprises exciting the fundamental acoustic waves in the structure having first and second fundamental frequencies (f₁ and f₂), wherein the secondary acoustic waves have first and second nonlinear interaction frequencies (f₃ and f₄) that are different than the first and second fundamental frequencies, and wherein determining the amplitudes comprises determining amplitudes of secondary acoustic waves having the first and second nonlinear interaction frequencies at the first and second fiber laser sensors, and wherein performing structural health monitoring comprises performing structural health monitoring based on the amplitudes of the secondary acoustic waves at the first and second nonlinear interaction frequencies.

Embodiment 11. The method of Embodiment 10, wherein determining the amplitudes comprises determine amplitudes of the fundamental acoustic waves having the first and second fundamental frequencies at the first and second fiber laser sensors (FLS1, FLS2) based on the first and second laser signals, and wherein performing structural health monitoring comprises performing structural health monitoring based on the amplitudes of the fundamental acoustic waves having the first and second fundamental frequencies at the first and second fiber laser sensors and based on the amplitudes of the secondary acoustic waves having the first and second nonlinear frequencies at the first and second fiber laser sensors (FLS1, FLS2).

Embodiment 12. The method of any of Embodiments 9-11, wherein performing structural health monitoring comprises performing structural health monitoring based on a comparison of the amplitudes of the fundamental and secondary acoustic waves at the first fiber laser sensor (FLS1) with amplitudes of the fundamental and secondary acoustic waves at the second fiber laser sensor (FLS2).

Embodiment 13. The method of any of Embodiments 9-12, wherein performing structural health monitoring comprises identifying a defect in the structure.

Embodiment 14. The method of Embodiment 13, wherein the defect comprises at least one of corrosion, cracking, and/or delamination.

Embodiment 15. The method of any of Embodiments 9-14, wherein the secondary acoustic waves are generated in the structure due to nonlinear wave mixing in response to the fundamental acoustic waves.

Embodiment 16. The method of any of Embodiments 9-15 further comprising: filtering out the second laser wavelength to generate a first digital signal corresponding to the first laser signal; and filtering out the first laser wavelength to generate a second digital signal corresponding to the second laser signal; wherein determining the amplitudes comprises determining the amplitudes based on the first and second digital signals.

Citations for the references cited in the present disclosure are provided below. Moreover, the disclosures of each of these references are hereby incorporated herein in their entireties by reference.
Reference [1]. CRANCH, G. A., et al., “Crack detection in riveted lap joints using fiber laser acoustic emission sensors,” Optics Express (US), Vol. 25, Iss. 16, pages 19457-19467, Aug. 3, 2017.
Reference [2]. CHEN, H., et al., “Nonlinear Lamb Wave Analysis for Microdefect Identification in Mechanical Structural Health Assessment,” Measurement (NL), Vol. 164, Iss. 2, 108026, 11 pages, November 2020.
Reference [3]. WILLIAMS, C. R. S., et al., “Fiber Optic Distributed Sensing for Ship Hull Monitoring on the Expeditionary Fast Transport Ship,” Optical Fiber Sensors (US), paper W2.5, 4 pages, Aug. 29-Sep. 2, 2022.
Reference [4]. WILLIAMS, C. R. S., et al., “Multichannel Fiber Laser Acoustic Emission Sensor System for Crack Detection and Location in Accelerated Fatigue Testing of Aluminum Panels,” APL Photon. (US), Vol. 5, Iss. 3, 030803, 11 pages, Mar. 20, 2020.
Reference [5]. JINGPIN, J., et al., “Nonlinear Lamb Wave-Mixing Technique for Micro-Crack Detection in Plates,” Ndt & E International (NL), Col. 85, pages 63-71, January 2017.
Reference [6]. NAVRATIL, A., et al., “Ultrasonic frequency response of fiber Bragg grating under direct and remote adhesive bonding configurations,” Meas. Sci. Technol. (UK), Vol. 33, 015204, 6 pages, Nov. 3, 2021.
Reference [7]. BALVANTIN, A., et al., “The Suitability of Using 3D PLA Printed Wedges for Ultrasonic Wave Propagation,” IEEE Access (US), DOI 10.1109/ACCESS.2020.2967211, 5 pages, 2020.
Reference [8]. WILLIAMS, C. R. S., et al., “Fiber Laser Sensor Detection of Acoustic Emissions from Stress Corrosion Cracking in Aluminum,” Optical Fiber Sensors (US), paper W4.47, 4 pages, Jun. 8-12, 2020.
Reference [9]. CRANCH, G. et al., “Towards Attometer/HZ1/2 Displacement Resolution in DFB Fiber Laser Acoustic Emission Sensors,” In Conference on Lasers and Electro-Optics, OSA Technical Digest (US), paper AW1J.4, 2 pages, Jun. 5-10, 2016.
Reference [10]. Nichols, J. M., et al. “Time Delay Estimation Via Wasserstein Distance Minimization,” IEEE Signal Processing Letters (US), Vol. 26, Iss. 6, pages 908-912, June 2019.
Reference [11]. MASUDA, A., European Patent Application No. EP2246695A1, “Method and Device of Diagnosing Damage of Structural Object,” published Nov. 3, 2010.
Reference [12]. CRANCH, G., U.S. Pat. No. 10,495,610B2, “Fiber Optic Acoustic Emission Sensor and Apparatus,” issued Dec. 3, 2019.

Additional disclosure is provided below.

The terminology used herein is for the purpose of describing particular embodiments only and is not intended to be limiting of inventive concepts. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof. The term “and/or” includes any and all combinations of one or more of the associated listed items.

It will be understood that, although the terms first, second, third, etc. may be used herein to describe various elements, these elements should not be limited by these terms. These terms are only used to distinguish one element from another element. Thus, a first element discussed herein could be termed a second element without departing from the scope of the present inventive concepts.

It will also be understood that when an element is referred to as being “on”, “coupled” to/with, or “connected” to/with another element, it can be directly on, directly coupled to/with, or directly connected to/with the other element, or intervening elements may be present. In contrast, when an element is referred to as being “directly on”, “directly coupled” to/with, or “directly connected” to/with another element, there are no intervening elements present. Similarly, when an operation/element is referred to as being “responsive to” or “in response to” another event/operation/element, it can be directly responsive to or directly in response to the other operation/element or intervening events/operations/elements may be present. In contrast, when an operation/element is referred to as being “directly responsive to” or “directly in response to” another event/operation/element, there are no intervening events/operations/elements present.

Unless otherwise defined, all terms (including technical and scientific terms) used herein have the same meaning as commonly understood by one of ordinary skill in the art to which the inventive concepts herein belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The operations of any methods disclosed herein do not have to be performed in the exact order disclosed, unless an operation is explicitly described as following or preceding another operation and/or where it is implicit that an operation must follow or precede another operation. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the description herein.

While inventive concepts have been particularly shown and described with reference to examples of embodiments thereof, it will be understood that various changes in form and details may be made therein without departing from the spirit of concepts and/or embodiments disclosed herein and/or without departing form the spirit and/or scope of the following claims.

1. A sensor system for a structure to be monitored, the sensor system comprising:
an optical fiber;
a pump laser that provides a pump laser signal having a pump laser wavelength in the optical fiber;
first and second fiber laser sensors arranged in series along the optical fiber, wherein each of the first and second fiber laser sensors is mounted on the structure, wherein the first fiber laser sensor provides a first laser signal having a first laser wavelength responsive to the pump laser signal, wherein the second fiber laser sensor provides a second laser signal having a second laser wavelength, wherein the first and second laser wavelengths are different;
a transducer mounted on the structure to be tested, wherein the transducer is configured to generate fundamental acoustic waves in the structure having a fundamental frequency, wherein secondary acoustic waves are generated in the structure in response to the fundamental acoustic waves, wherein the secondary waves have a nonlinear interaction frequency that is different than the fundamental frequency, wherein the first laser wavelength varies in response to the fundamental and secondary acoustic waves, and wherein the second laser wavelength varies in response the fundamental and secondary acoustic waves; and
a controller coupled with the optical fiber, wherein the controller is configured to determine amplitudes of the secondary acoustic waves having the nonlinear interaction frequency at the first and second fiber laser sensors based on the first and second laser signals having the respective first and second laser wavelengths, and to perform structural health monitoring based on the amplitudes of the secondary waves at the first and second fiber laser sensors.

2. The sensor system of claim 1, wherein the transducer is configured to generate the fundamental acoustic waves in the structure having first and second fundamental frequencies, wherein the secondary acoustic waves have first and second nonlinear interaction frequencies that are different than the first and second fundamental frequencies, and wherein the controller is configured to determine amplitudes of secondary acoustic waves having the first and second nonlinear interaction frequencies at the first and second fiber laser sensors, and wherein the controller is configured to perform structural health monitoring based on the amplitudes of the secondary acoustic waves at the first and second nonlinear interaction frequencies.

3. The sensor system of claim 2, wherein the controller is further configured to determine amplitudes of the fundamental acoustic waves having the first and second fundamental frequencies at the first and second fiber laser sensors based on the first and second laser signals, and wherein the controller is configured to perform structural health monitoring based on the amplitudes of the fundamental acoustic waves having the first and second fundamental frequencies at the first and second fiber laser sensors and based on the amplitudes of the secondary acoustic waves having the first and second nonlinear frequencies at the first and second fiber laser sensors.

4. The sensor system of claim 1, wherein the controller is configured to perform structural health monitoring based on a comparison of the amplitudes of the fundamental and secondary acoustic waves at the first fiber laser sensor with amplitudes of the fundamental and secondary acoustic waves at the second fiber laser sensor.

5. The sensor system of claim 1, wherein performing structural health monitoring comprises identifying a defect in the structure.

6. The sensor system of claim 5, wherein the defect comprises at least one of corrosion, cracking, and/or delamination.

7. The sensor system of claim 1, wherein the secondary acoustic waves are generated in the structure due to nonlinear wave mixing in response to the fundamental acoustic waves.

8. The sensor system of claim 1 further comprising:
an optical processor coupled between the optical fiber and the controller, wherein the optical processor is configured to filter out the second laser wavelength to generate a first digital signal corresponding to the first laser signal and to filter out the first laser wavelength to generate a second digital signal corresponding to the second laser signal, wherein the controller is configured to determine the amplitudes based on the first and second digital signals.

9. A method of monitoring a structure using first and second fiber laser sensors mounted at respective first and second locations on the structure, wherein the first and second fiber laser sensors are arranged in series along an optical fiber, the method comprising:
providing a pump laser signal having a pump laser wavelength in the optical fiber;
exciting fundamental acoustic waves at a third location on the structure spaced apart from the first and second locations, wherein the fundamental acoustic waves have a fundamental frequency, wherein secondary acoustic waves are generated in the structure in response to the fundamental acoustic waves, and wherein the secondary acoustic waves have a nonlinear interaction frequency that is different than the fundamental frequency;
generating a first laser signal from the first fiber laser sensor in response to the pump laser signal, wherein the first laser signal has a first laser wavelength that varies in response to the fundamental and secondary acoustic waves at the first location on the structure;
generating a second laser signal from the second fiber laser sensor in response to the pump laser signal, wherein the second laser signal has a second laser wavelength that varies in response the fundamental and secondary acoustic waves at the second location on the structure, wherein the first and second laser wavelengths are different;
determining amplitudes of the secondary acoustic waves having the nonlinear interaction frequency at the first and second fiber laser sensors based on the first and second laser signals having the respective first and second laser wavelengths; and
performing structural health monitoring based on the amplitudes of the secondary waves at the first and second fiber laser sensors.

10. The method of claim 9,
wherein exciting the fundamental acoustic waves comprises exciting the fundamental acoustic waves in the structure having first and second fundamental frequencies, wherein the secondary acoustic waves have first and second nonlinear interaction frequencies that are different than the first and second fundamental frequencies, and
wherein determining the amplitudes comprises determining amplitudes of secondary acoustic waves having the first and second nonlinear interaction frequencies at the first and second fiber laser sensors, and
wherein performing structural health monitoring comprises perform structural health monitoring based on the amplitudes of the secondary acoustic waves at the first and second nonlinear interaction frequencies.

11. The method of claim 10,
wherein determining the amplitudes comprises determine amplitudes of the fundamental acoustic waves having the first and second fundamental frequencies at the first and second fiber laser sensors based on the first and second laser signals, and
wherein performing structural health monitoring comprises performing structural health monitoring based on the amplitudes of the fundamental acoustic waves having the first and second fundamental frequencies at the first and second fiber laser sensors and based on the amplitudes of the secondary acoustic waves having the first and second nonlinear frequencies at the first and second fiber laser sensors.

12. The method of claim 9, wherein performing structural health monitoring comprises performing structural health monitoring based on a comparison of the amplitudes of the fundamental and secondary acoustic waves at the first fiber laser sensor with amplitudes of the fundamental and secondary acoustic waves at the second fiber laser sensor.

13. The method of claim 9, wherein performing structural health monitoring comprises identifying a defect in the structure.

14. The method of claim 13, wherein the defect comprises at least one of corrosion, cracking, and/or delamination.

15. The method of claim 9, wherein the secondary acoustic waves are generated in the structure due to nonlinear wave mixing in response to the fundamental acoustic waves.

16. The method of claim 9 further comprising:
filtering out the second laser wavelength to generate a first digital signal corresponding to the first laser signal; and
filtering out the first laser wavelength to generate a second digital signal corresponding to the second laser signal;
wherein determining the amplitudes comprises determining the amplitudes based on the first and second digital signals.

17. A sensor system for a structure to be monitored, the sensor system comprising:
first and second fiber laser sensors on the structure, wherein the first fiber laser sensor provides a first laser signal, and wherein the second fiber laser sensor provides a second laser signal;
a transducer mounted on the structure to be tested, wherein the transducer is configured to generate fundamental acoustic waves in the structure, wherein the fundamental acoustic waves have a fundamental frequency, wherein secondary acoustic waves are generated in the structure in response to the fundamental acoustic waves, wherein the secondary waves have a nonlinear interaction frequency that is different than the fundamental frequency, wherein a wavelength of the first laser signal varies in response to the fundamental and secondary acoustic waves, and wherein a wavelength of the second laser signal varies in response the fundamental and secondary acoustic waves; and
a controller coupled with the first and second fiber laser sensors, wherein the controller is configured to determine amplitudes of the secondary acoustic waves having the nonlinear interaction frequency based on variations of the wavelength of the first laser signal and based on variations of the wavelength of the second laser signal, and to perform structural health monitoring based on the amplitudes of the secondary waves.

18. The sensor system of claim 17,
wherein the fundamental acoustic waves comprises first and second fundamental acoustic waves having respective first and second fundamental frequencies, wherein the secondary acoustic waves have first and second nonlinear interaction frequencies that are different than the first and second fundamental frequencies,
wherein the controller is configured to determine amplitudes of secondary acoustic waves having the first and second nonlinear interaction frequencies, and
wherein the controller is configured to perform structural health monitoring based on the amplitudes of the secondary acoustic waves at the first and second nonlinear interaction frequencies.

19. A method of monitoring a structure using first and second fiber laser sensors on the structure, the method comprising:
exciting fundamental acoustic waves in the structure, wherein the fundamental acoustic waves have a fundamental frequency, wherein secondary acoustic waves are generated in the structure in response to the fundamental acoustic waves, and wherein the secondary acoustic waves have a nonlinear interaction frequency that is different than the fundamental frequency;
generating a first laser signal from the first fiber laser sensor, wherein a wavelength of the first laser signal varies in response to the fundamental and secondary acoustic waves;
generating a second laser signal from the second fiber laser sensor, wherein a wavelength of the second laser signal varies in response the fundamental and secondary acoustic waves;
determining amplitudes of the secondary acoustic waves having the nonlinear interaction frequency based on variations of the wavelength of the first laser signal and based on variations of the wavelength of the second laser signal; and
performing structural health monitoring based on the amplitudes of the secondary waves.

20. The method of claim 19,
wherein the fundamental acoustic waves comprise first and second fundamental acoustic waves having respective first and second fundamental frequencies, wherein the secondary acoustic waves have first and second nonlinear interaction frequencies that are different than the first and second fundamental frequencies,
wherein determining the amplitudes comprises determining amplitudes of secondary acoustic waves having the first and second nonlinear interaction frequencies, and
wherein performing structural health monitoring comprises perform structural health monitoring based on the amplitudes of the secondary acoustic waves at the first and second nonlinear interaction frequencies.
